(19) United States
(12) Patent Application Publication
(10) Pub. No.: US 2004/0187725 A1
(43) Pub. Date: Sep. 30, 2004

(54) Method and apparatus for providing a partitioned between-car barrier for transportation vehicles

(75) Inventors: George R. Kennedy, Arcadia, CA (US); Sudhir K. Agrawal, Arcadia, CA (US)

Correspondence Address: Bingham McCutchen LLP, Suite 1800, Three Embarcadero Center, San Francisco, CA, 94111-4067, US

(73) Assignee: Los Angeles County Metropolitan Transportation Authority

(21) Appl. No.: 10/741,734

(22) Filed: Dec. 19, 2003

Related U.S. Application Data
(63) Continuation-in-part of application No. 09/808,519, filed on Mar. 14, 2001, now Pat. No. 6,694,890.

(51) Int. Cl. B60D 5/00

(52) U.S. Cl. 105/8.1

(57) ABSTRACT

An apparatus and method for providing partitioned barrier members that form a barrier that restricts the space between cars of multi-car transportation vehicles. Barrier members extend from adjacent vehicle cars or mounts attached thereto and cooperate to form the barrier. The barrier members can assume a relaxed state, such as when vehicle cars are substantially aligned, and deformed or compressed states, such as when the vehicle cars travel along a sufficiently large curve. The barrier deters passengers from inadvertently and/or accidentally walking between cars of the multi-car transportation vehicle, thereby reducing the risk of injury.

### CROSS-REFERENCE TO RELATED APPLICATION

The present application is a Continuation-In-Part (CIP) of co-pending patent application Ser. No. 09/808,519, filed Mar. 14, 2001, priority of which is hereby claimed under 35 U.S.C. §120, and which is expressly incorporated herein by reference as though set forth in full.

### FIELD OF THE INVENTION

The present invention relates to a method and an apparatus for enhancing the safety of multi-car transportation vehicles and, more particularly, to flexible, partitioned between-car barrier members that warn persons in the vicinity of a vehicle and prevent and deter persons from entering a space between vehicle cars.

### DESCRIPTION OF RELATED ART

Various transportation service providers utilize vehicles that have interconnected compartments or cars, such as light rail systems, trains, subways, trolleys, monorails and buses. When multiple vehicle cars or compartments are employed, however, there is an inherent risk of injury to passengers, onlookers and others in the vicinity of the vehicle who, for whatever reason, find themselves between vehicle cars.

For example, a person may enter a space between vehicle cars due to inattention during the boarding or disembarking process, or simply while they are in the area of the vehicle, where no between-car barrier is provided. Accidents of varying degrees can result from entering the space between vehicle cars including falling from a boarding platform between cars, falling into the pathway of vehicle cars, e.g., onto train tracks, and becoming entangled in coupling mechanisms. These accidents can result in serious injuries and death. These risks are particularly acute in situations involving raised platforms and persons having certain disabilities, such as blindness.

Some known between-car barriers include gates, chains, alarmed motion detectors, inflatable enclosures, and human guards. Such systems have shortcomings that are known in the industry, including high costs, high maintenance and possible failure to successfully deter and warn people of impending dangers. Further, some known barriers are not effective at typical transportation speeds and paths. For example, some barriers flap or buckle in the wind at typical transportation speeds, for example, 50-70 miles per hour (mph) for a train or light rail. Other barriers are not adaptable to curves.

Further, transportation providers face these problems when they are obligated to meet local, state and federal laws and regulations directed to preventing, deterring, and warning individuals from inadvertently stepping off a platform between cars. See e.g., American Disability Act (1990); Specifications for Transportation Vehicles, 49 C.F.R. §§ 38 and 38.85. Additionally, certain barrier members must also meet other regulations that set forth toxicity and flamability specification.

There is a need, therefore, for between-car safety devices that can be installed on existing and new transportation vehicles, effectively operate at different vehicle speeds and positions, and meet requirements set forth in relevant laws and regulations.

### SUMMARY OF THE INVENTION

In accordance with one embodiment, an apparatus for restricting access to a space between adjacent vehicle cars includes first and second deformable barrier members that are secured to respective first and second vehicle cars. At least one of the barrier members is partitioned. The barrier members extend from their respective vehicle cars and cooperate to form a barrier and an open space above the barrier. The barrier restricts access to the space between the first and second vehicle cars.

In another embodiment, an apparatus for restricting access to a space between adjacent vehicle cars includes first and second flexible partitioned members and first and second mounts. The mounts are configured to be connected to respective first and second adjacent vehicles, and the partitioned members are secured to respective mounts. The partitioned members extend from the mounts and cooperate to form a barrier and an open space above said barrier. The barrier restricts access to the space between the first and second vehicle cars.

In a further embodiment, a method for restricting access to a space between two adjacent vehicle cars includes providing first and second flexible partitioned barrier members and first and second mounts, securing the mounts to vehicle cars, and securing the barrier members to respective mounts. The first and second barrier members extend from respective vehicle cars and cooperate to form a barrier and an open space above the barrier. The barrier restricts access to the space between the vehicle cars.

In apparatus and method embodiments, one or both barrier members can be partitioned. A partitioned barrier member can include one or multiple partition segments. Thus, a partitioned barrier member can define different numbers of apertures or cavities that extend for different lengths of the member. Further barrier members can be about the same shape and size. Barrier members can also extend for different lengths depending on the space between vehicle cars. For example, barrier members can extend from vehicles to form a barrier that defines a space of about 2″ to about 4″ between the members.

In apparatus and method embodiments, a partitioned barrier member includes a flexible outer wall, such as a loop or member having straight sections bounded by an arcuate section, and one or more partition segments, such as a stiffening member. The one or more partition segments are bounded by the outer wall and can extend between different members, e.g., between sections of the outer wall, between a partition segment and a section of the outer wall, and between other partition segments. Partition segments may be parallel to each other or at an angle.

In apparatus and method embodiments, first and second mounts are connected to first and second vehicle cars, and the first and second barrier members are secured to the mounts. The barrier members can be fixed or removeably secured, e.g., slideably secured, to a mount.

### BRIEF DESCRIPTION OF THE DRAWINGS

Referring now to the drawings, in which like reference numbers represent corresponding parts throughout, and in which:

FIG. 1 is a top view of an embodiment of a barrier including flexible, partitioned between-car barrier members having a stiffening member and that are mounted to two adjoining vehicle cars;

FIG. 1A is a perspective view of a partitioned, flexible between-car barrier having a partition or stiffening segment that is attached to a mount;

FIG. 1B is a top view of an embodiment of a partitioned, flexible between-car barrier member having a stiffening member that is attached to a mount;

FIG. 1C is a side view of an interlocking mechanism to attach a partitioned, flexible barrier member and a mount;

FIG. 1D is a top view of a face plate of a mount;

FIG. 1E is a top view of an interlocking slot;

FIG. 1F illustrates an alternative attachment mechanism to connect a partitioned, flexible barrier member and a mount;

FIG. 2 is a top view of an embodiment of a, between-car barrier having flexible, partitioned barrier members that include a stiffening member and that are mounted to two adjoining vehicle cars in an angled or skewed orientation;

FIG. 3 is a top view of an embodiment of between-car barrier having flexible, partitioned barrier members that include a stiffening member and that are mounted to two adjoining vehicle cars in another angled or skewed orientation;

FIGS. 4A-C illustrate respective side, top and perspective views of an embodiment of a partitioned between-car barrier having multiple partition segments;

FIGS. 4D-F illustrate top views of other embodiments of partitioned barrier members;

FIG. 5 illustrates a top view of another alternative flexible partitioned barrier member;

FIGS. 6A-C are various views of a flexible partitioned between-car barrier member having multiple partition segments;

FIGS. 7A-B illustrate inter-connecting components that can be used to attach a flexible partitioned barrier member to a mount;

FIGS. 8A-C illustrate vehicle cars with flexible partitioned barrier members having multiple partition segments that are substantially aligned and at angled or skewed orientations;

FIGS. 9A-C illustrate partitioned barrier members of vehicle cars around in a relaxed state; and

FIGS. 9D-E illustrate partitioned barrier members in a deformed or compressed state as a result of Vehicle cars traversing a sufficiently sharp curve.

### DETAILED DESCRIPTION OF ILLUSTRATED EMBODIMENTS

Flexible, partitioned barrier members or extensions are mounted to multi-car vehicles or vehicle cars. One or both of the flexible barrier members can be segmented or partitioned using various stiffening and partition members or segments. Partitioned barrier members may be attached directly to the vehicle car or attached to a mount, which is attached to a vehicle car. Partitioned barrier members are flexible and can assume a relaxed state (e.g., when vehicle cars are aligned) and a deformed or a compressed state (e.g., when vehicle cars traverse a sufficiently sharp curve). Barrier members cooperate with each other to form a barrier and an open space above the barrier. The barrier blocks and deters persons from entering the space between vehicle cars.

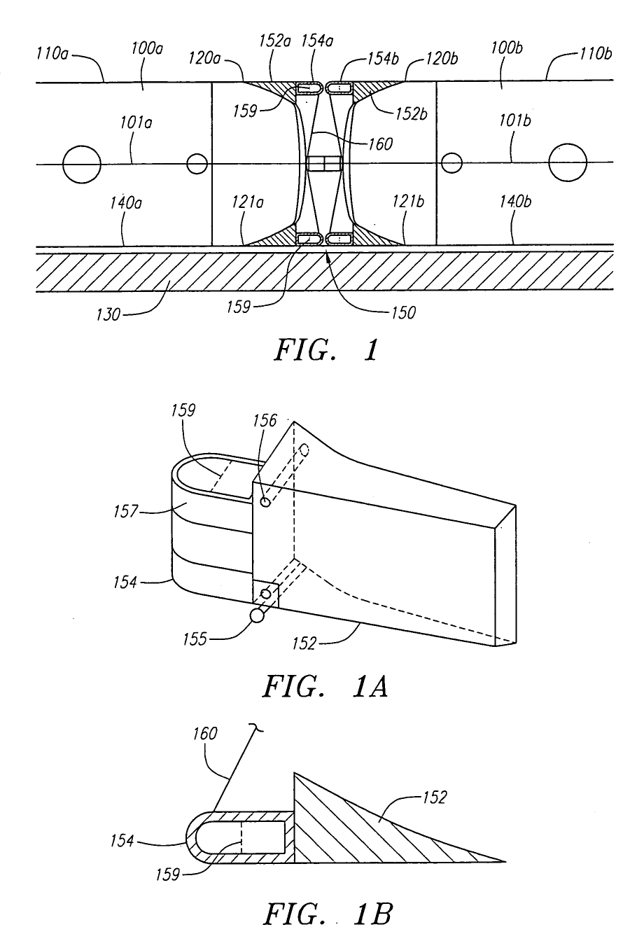

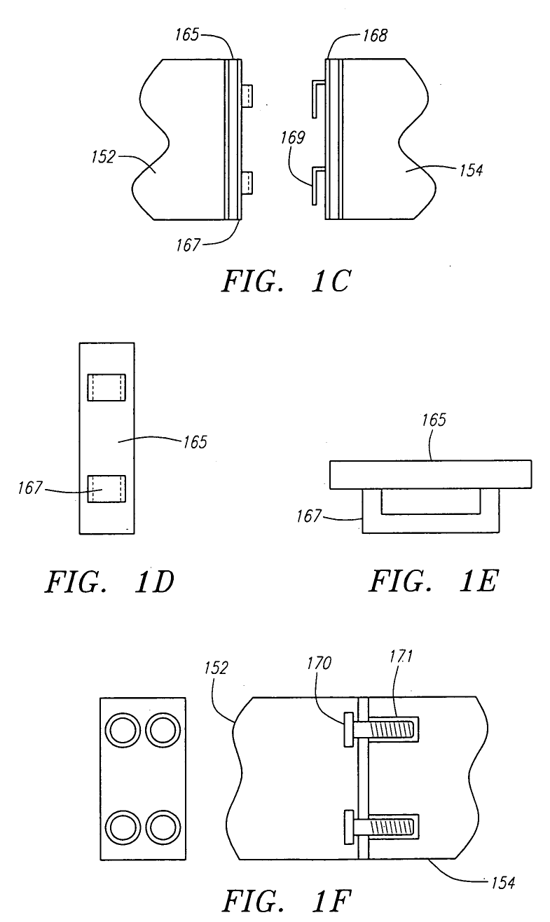

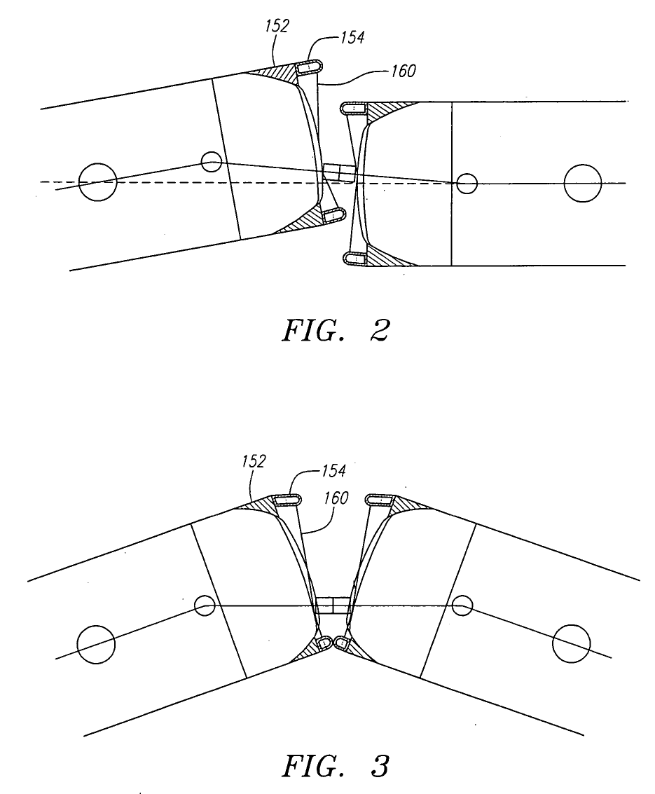

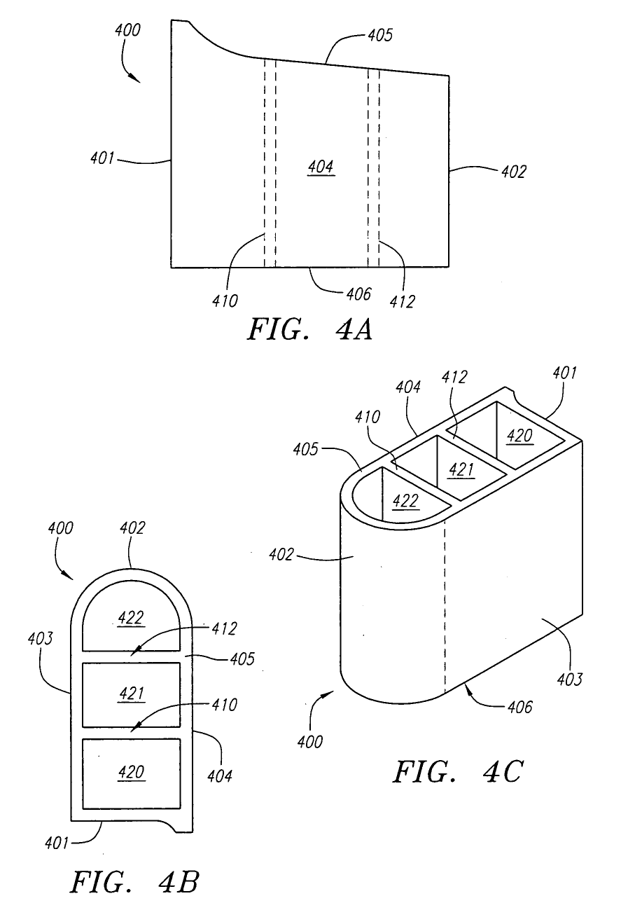

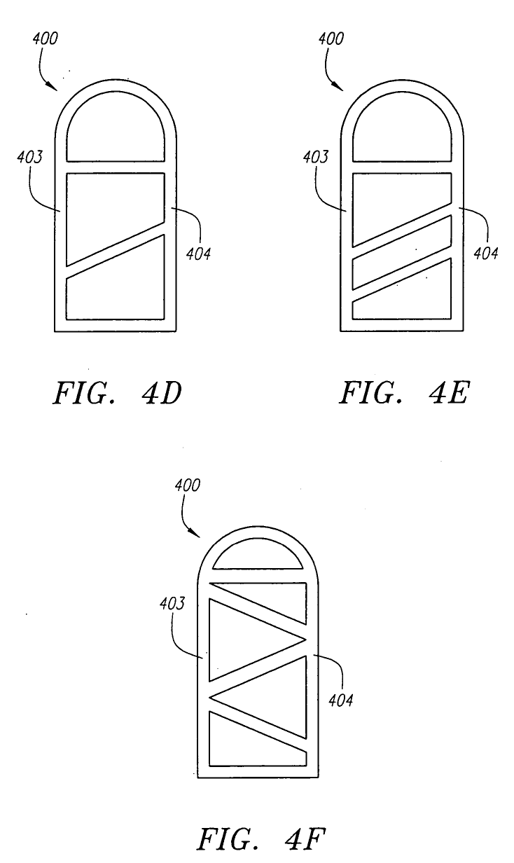

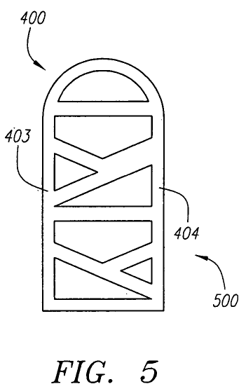

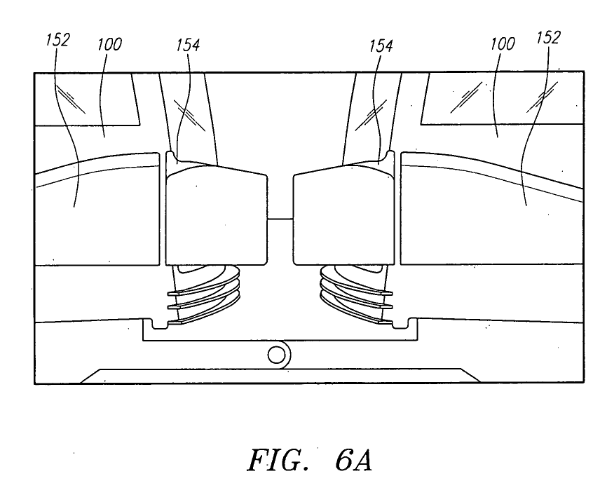

In one embodiment, referring to FIGS. 1A-C, first and second adjacent vehicle cars 100a and 100b (generally 100) have a longitudinal center line 101a and 101b (generally 101). Embodiments of a partitioned between-car barrier may be utilized on the outer longitudinal edges 110a and 100b (generally 110) of the vehicle cars 100 or other areas where the vehicle cars 100 may be subject to boarding from one or more sides of the center line 101.

Each longitudinal edge 110 has a first end 120a and 120b (120) and second end 121a and 121b (generally 121). Similarly, the vehicle may be configured so that the station platform 130 is adjacent to one longitudinal edge of the vehicle, e.g., edges 140a and 140b (140). Embodiments of a partitioned multi-car barrier member can be used along a longitudinal edge of the vehicle cars that is the side on which loading and unloading of passengers or material occurs, and is the area that will normally have persons present.

FIG. 1A illustrates a perspective view of one embodiment of a partitioned between-car barrier 154. The barrier member 154 is attached to a mount 152, which is attached to a vehicle car 100 (FIG. 1). A partitioned barrier member 154 may be a flexible or semi-rigid rubber loop, or an articulating extension, and includes one or more stiffening or partition segments or members. For example, as shown in FIG. 1A-B, a partition or stiffening segment 159 extends across two sides of a barrier member 154. The stiffening segment 159 provides improved stability to the member 154 (e.g., at higher speeds), while also allowing the member 154 to flex and bend when compressed or a deformed state.

A barrier member 154 can be constructed of a fiber, rubber or like materials. Barrier member material should also satisfy flammability and toxicity requirements set forth in pertinent laws and regulations. Accordingly, persons of ordinary skill in the art will appreciate that various barrier member materials can be utilized depending on, for example, the particular vehicle, application, size and shape of barrier member, and relevant laws and regulations.

A mount 152 may be constructed of a light weight composite or aluminum or other suitable material. As shown in FIG. 1, mounts 152 may be designed to conform and rest flush with the shape of the vehicle car 100. The shape and dimensions of mounts 152 and flexible barrier members or extensions 154 may vary depending on various factors including, the size of the vehicle cars, the distance by which the cars are separated when they are in a loading and unloading condition and the radius of any turns or curves it will make. For example, longer mounts 152 and/or barrier members 154 may be utilized for light rail systems that utilize cars that are separated by greater distances.

If necessary, referring to FIGS. 1 and 1B, a positioning member 160 may be connected to a barrier member 154 to provide additional stability, for example, to prevent the barrier member 154 from extending beyond the vehicle envelope. As shown in FIG. 1, a positioning member 160 is connected to each barrier member 154 and is anchored to the vehicle car 100. Exemplary positioning members 160 include bungee cords and other flexible and rubber materials. These members 160 ensure that the vehicle car can make turns or travel on a curve without endangering persons standing nearby and without interfering with a structure or wall adjacent to the path of the vehicle.

The mount 152 can be attached to a vehicle car 100 using various connectors. For example, as shown in FIG. 1A, the mount 152 can be attached to a vehicle car 100 using one or more pin connectors 155 that are inserted through one or more openings or apertures 156 through the mount 152.

Further, various connecting mechanisms can be used to attach the mount 152 and barrier member 154 components together. For example, as shown in FIGS. 1C-E, one suitable interlocking mechanism includes an end plate 165 that includes one or more slots 167 and a plate 168 with corresponding hooks 169. Insertion of a hook 169 on the end plate 168 into a slot 167 on the mount end plate 165 interconnects the secured mount 152 to the flexible barrier member 154. Another example of a suitable interlocking mechanism is shown in FIG. 1F. In this mechanism, one or more bolts 170 are threaded between the flexible barrier member 154 and the mount 152 with corresponding nuts 171. Thus, the barrier member 154 can be permanently or temporarily attached to a mount 152 or vehicle with different mounting and connection mechanisms. This may be useful when, for example, a barrier member 154 is to be removed from a vehicle car 100 and stored on a vehicle, and later, reattached when the vehicle returns to service.

Additionally, as shown in FIG. 1A, the barrier member 154 may include certain colors or reflective coatings for added visibility or safety. For example, the member 154 can include a reflective yellow strip 157.

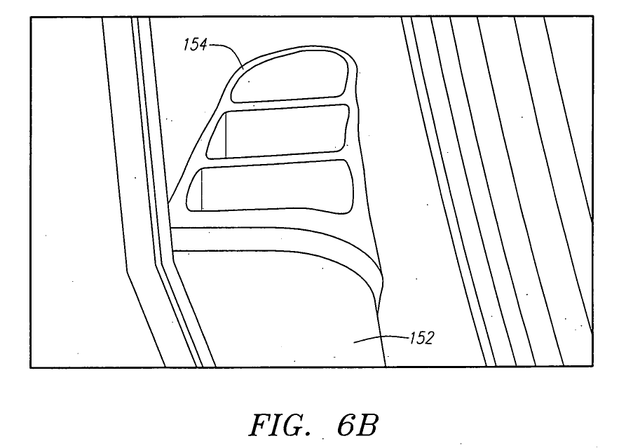

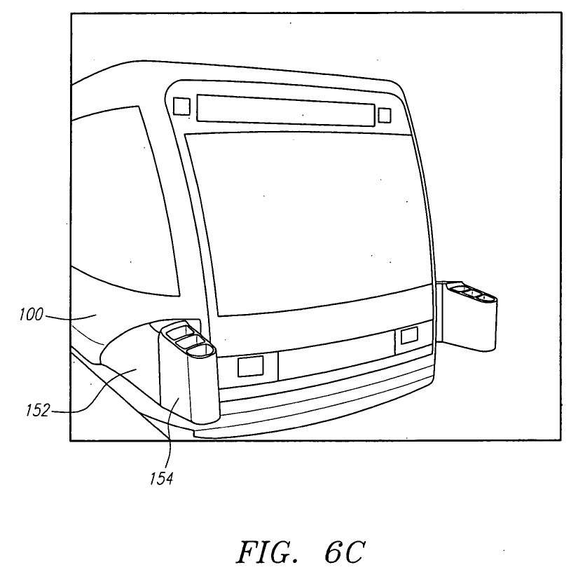

Referring to FIGS. 1, 2 and 3, between-car barrier members 154 are mounted on one or more longitudinal edges of adjacent cars 100 of a vehicle. The barrier members 154 provide a barrier to prevent persons from entering the area between vehicle cars. Moreover, when the vehicle turns or traverses a curve, as illustrated in FIGS. 2 and 3, the optional positioning members 160 can ensure that the flexible members 154 do not extend beyond the envelope or footprint in which the vehicle moves, thereby avoiding collisions or interference with objects or persons in the area of the vehicle.

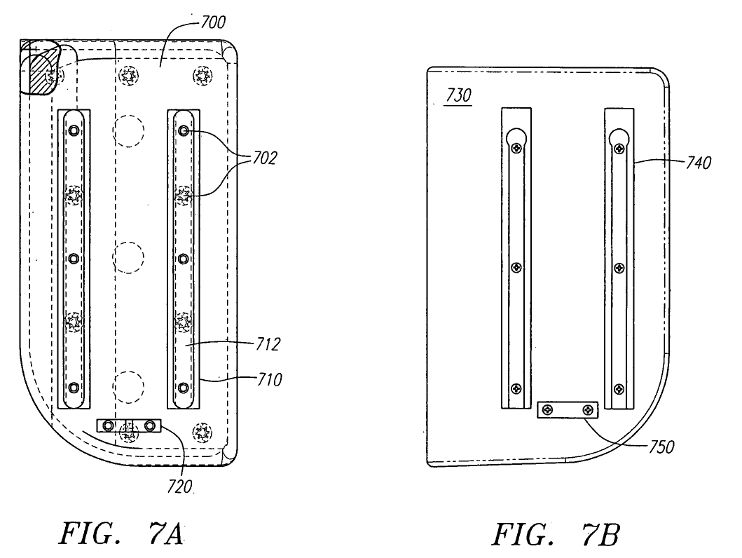

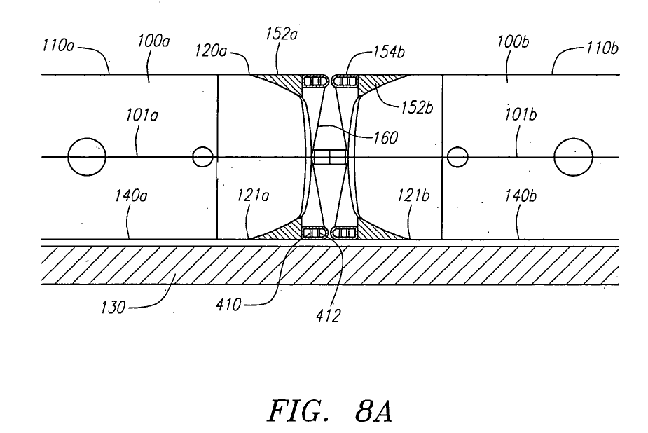

FIGS. 4A-F and 5 illustrate alternative embodiments of a flexible and deformable partitioned barrier member or loop 154. In particular, in one embodiment, shown in FIGS. 4A-C, a partitioned barrier member 400 includes a first wall or surface 401 that is attached to a vehicle car 100 (or a mount 152), an arcuate outer or end wall 402, side walls or surfaces 403 and 404, and top and bottom surfaces 405 and 406. One or more partition members extend between one or more walls. In the illustrated embodiment, partition members 410 and 412 (generally 410) extend between the outer walls 403 and 404 to define apertures or cavities 420-422. As previously discussed, the partitioned configuration is advantageous in that it provide additional stability, while also allowing the members to bend and flex to assume both relaxed and deformed states, e.g., when barrier members contact each other when the vehicle cars travel around a sufficiently sharp curve.

In the embodiment shown in FIGS. 4A-C, a partitioned. barrier member 400 includes two partition segments 410 and 412 that extend across the router wall sections 403 and 404 to define apertures 420-422. In the illustrated embodiment, the segments 410 and 412 are generally parallel with each other and orthogonal to the wall sections 403 and 404. As a result, the apertures 420 and 421 are generally rectangular, and the aperture 422 at the end of the barrier member is generally semi-circular. Further, as shown in FIG. 4A, the partition segments 410 and 412 (dotted lines) extend completely along a height of a partition member. Thus, the apertures are formed in a vertical direction and extend through barrier member.

The invention, however, is not so limited. For example, the partition segments 410 may extend only partially along a height of a barrier member 400. Additionally, rather than utilizing apertures that extend completely through a barrier member, a partitioned barrier member can include one or more horizontal sections that form cavities, which partially extend through a barrier member 400. Further, depending on the barrier member 400 configuration, partition segments 410 can be arranged so that one or more cavities extend horizontally.

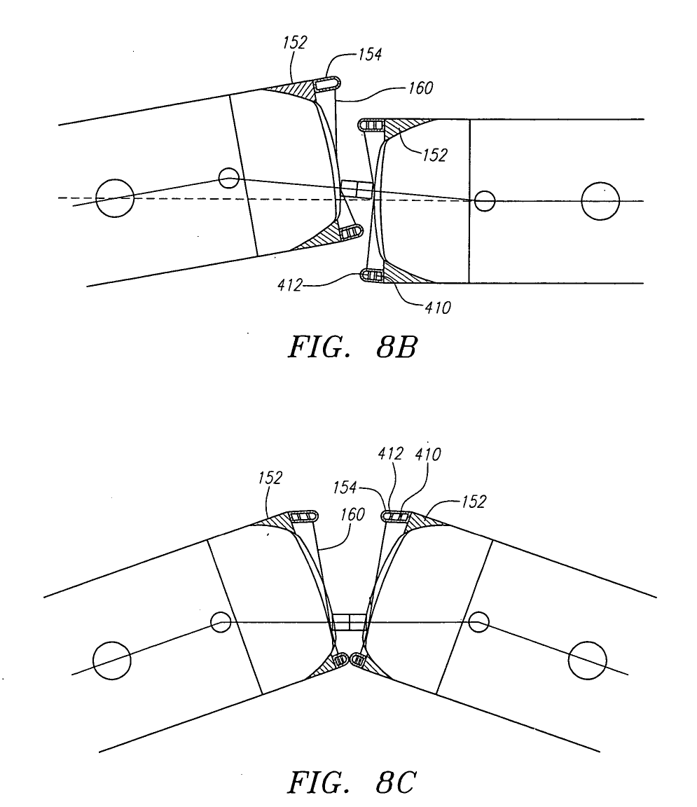

Thus, persons of ordinary skill in the art will appreciate that a partitioned barrier member 400 can include various numbers of partition members or segments 410, such as one segment (FIGS. 1A-B), two segments (FIGS. 4A-C), and other numbers of segments, e.g., three and four partition segments (FIGS. 4D-4E, 5). The number of partition members 410 may depend on, for example, the rigidity, flexibility, weight, and length of the barrier member 400. Thus, FIGS. 1A-B, 4A-F and 5 are merely illustrative of possible numbers and arrangements of partition segments 410, and are not intended to be limiting.

Further, as illustrated, two complimentary flexible partitioned members that form a barrier can be approximately the same size and shape. Other embodiments may have different size and shape relationships depending on the particular applications and vehicle configurations.

In addition to using various numbers of partition segments 410, the partition segments 410 can extend between different barrier member walls at various angles. For example, the embodiment shown in FIGS. 4A-C includes two partition members 410 and 412 that are generally parallel to each other and orthogonal to the outer walls 403 and 404. As shown in FIGS. 4D-F other numbers of partition segments 410 can be arranged at different angles with respect to the outer walls 403 and 404 so that they may (or may not be) parallel to each other. Thus, none, some or all of the partition members may be orthogonal to the outer walls 403 and 404. The number and angle of partition members may depend on, for example, the rigidity, flexibility, weight, and length of the barrier member.

In alternative embodiments, as shown generally in FIG. 5, partition segments can be configured to extend between outer walls and/or other partition segments to form a “web” or other interconnected pattern 500. For example, some partition segments may be parallel to each other, whereas others are not. Some partition segments may be generally orthogonal to the outer walls, whereas other partition segments may be at an angle other than 90 degrees relative to the outer walls. Further, some partition segments may extend between the outer walls, whereas other partition segments may extend between partition segments or between a partition segment and an outer wall. For purposes of illustration, but not limitation, this specification primarily refers to flexible barrier members having one or two partition segments.

Further, the shape or design of a partitioned between-car barrier member can be adapted to the particular transportation vehicle. For example, the barrier members shown in FIGS. 1 and 4A-C are configured for a train or light rail car. Thus, for example, sections 401 and 405 can be shaped to attach directly to the car. Alternatively, as illustrated, a barrier member can be attached to a mount 152, which is attached to the vehicle car. For example, a partitioned member can be fixed to a mount or removably secured to a mount (e.g., slidably secured). Further, if necessary, a component for removably securing a partitioned member to a mount may be integrated within the partitioned member. Indeed, other shapes and configurations may be suitable for other vehicles.

The sizes of flexible barrier members and partition members can also be adjusted as needed for different vehicles or other design considerations. For example, in the illustrated embodiment, as shown in FIGS. 4A-C, the outer walls and the partition members can have different widths, heights and thicknesses so that adjacent partition members can cooperate with each other to form a barrier. Depending on the length of the partitioned barrier members and the distance between vehicle cars, a gap of about 2″ to about 4″ can exist between the barrier members when the vehicle cars are generally aligned.

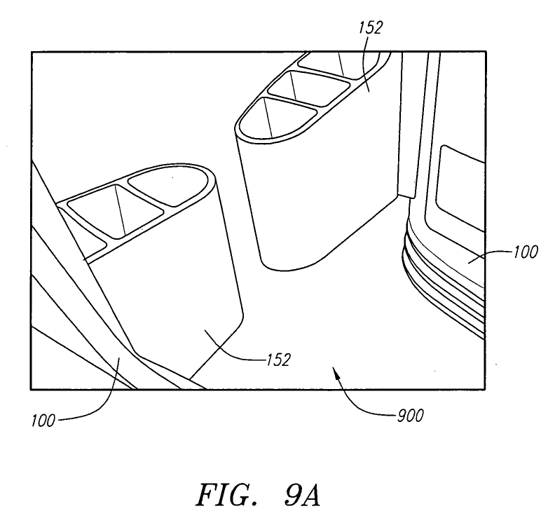

For example, referring to FIGS. 6A-C, flexible partitioned barrier members 154 having two partition segments and three apertures are shown as being attached to mounts 152, which are attached to vehicle cars 100. FIG. 6A illustrates a gap between the barrier members 154, e.g., about two to four inches. FIG. 5B illustrates how a flexible barrier member 154 may be designed to be generally flush or aligned with a mount 152 and/or side of a vehicle car 100.

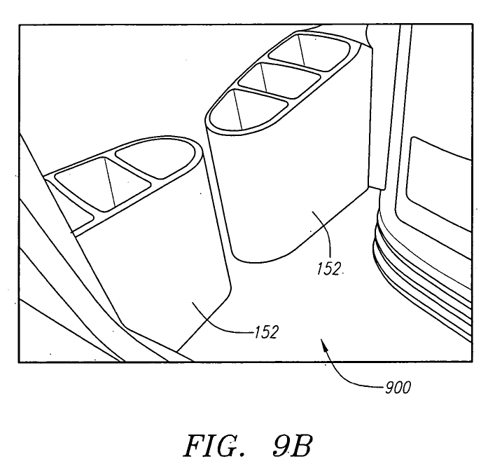

FIGS. 7A-B illustrate one embodiment of a connecting mechanism that can be used to attach a partitioned barrier member 154 to a mount 152, which is attached to a vehicle car 100. Referring to FIG. 7A, a base plate 700 can be inserted or integrated in a partitioned barrier member 154. The base plate 700 can include various connectors or connecting points 702 as needed. A slide member 710 with a raised section 712 and a stop 720 are attached to the base plate 700 via the connecting points 702. Referring to FIG. 7B, an outer face 730 of a mount 152 is configured with corresponding slotted or receiving members 740 and a stop 750. In use, a barrier member is positioned so that the raised male slide member section 712 is inserted into a corresponding female member 740 of the mount 152. Stop components 720 and 750 ensure that the barrier member slides down to a certain level and does not slide or fall further. Thus, the barrier member 154 can be removably secured, e.g., slidably secured, to a mount 152. Alternatively, a barrier member can be fixed to a mount 152 or a vehicle car 100.

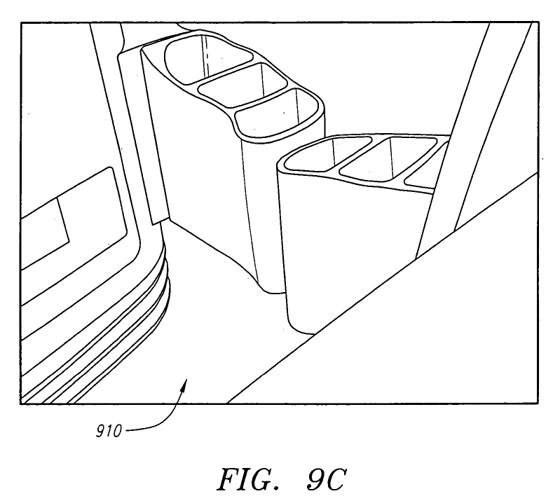

Referring to FIGS. 8A-B, partitioned barrier members, like the barrier members shown in FIG. 1, are generally straight and in a relaxed state when adjacent vehicle cars are generally aligned or traversing a slight curve. As the vehicle cars travel along a track and around a sufficiently sharp curve, as shown in FIGS. 8B-C, the inner partitioned barrier members come into contact with each other, whereas the outer barrier members become further separated. As previously discussed, if necessary, a positioning member 160, such as a bungee cord, can be connected to a partitioned barrier member for additional stability and to prevent the barrier members from extending beyond the travel envelope.

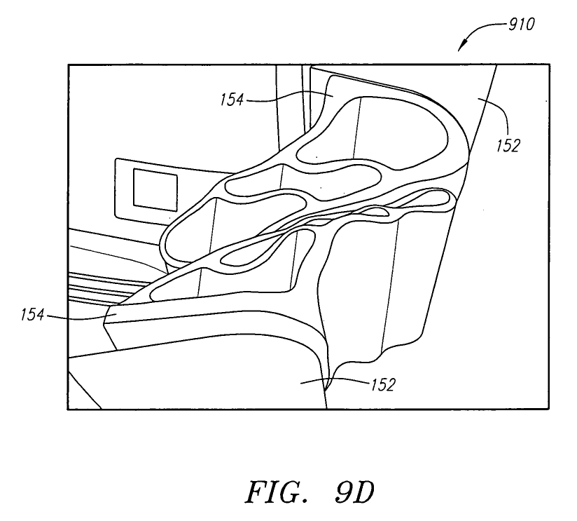

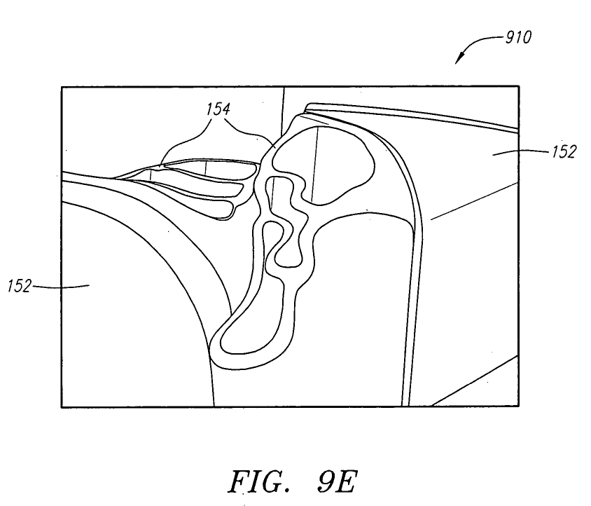

The manner in which partitioned barrier members come into contact with each other and change from a relaxed state to a deformed state is shown in FIGS. 9A-E. In FIG. 9A, partitioned barrier members 154 are in a relaxed state 900 when the vehicle cars 100 are generally aligned or traversing a slight curve. As the vehicle cars 100 begin to traverse a larger curve, the (inner) partitioned barrier members 154 approach each other until they contact each other, as shown in FIG. 9C and begin to bend or flex from their relaxed state 900 to a deformed state 910. As the vehicle cars 100 continue to travel along the curve, the curve angle may increase until the partitioned barrier members fully engage each other and, for example, compress, slide along, and/or abut each other, as shown in FIGS. 9D-E. After the vehicle cars pass the curve they may return to being substantially aligned, and the partitioned flexible barrier members 154 also return from a deformed state 910 to a relaxed state 900.

Persons of ordinary skill in the art will appreciate that other deformed state patterns can result from different partitioned barrier member configurations and the angle of the vehicle cars. Accordingly, FIGS. 9D and 9E are merely illustrative of various possible deformed states 910 of flexible partitioned barrier members 154.

Having described embodiments of a flexible, partitioned between-car barriers and related methods, persons of ordinary skill in the art will recognize that embodiments of such barriers can be attached to various vehicle cars, including vehicle cars that are loaded and unloaded via a station platform. Further, persons of ordinary skill in the art will recognize that embodiments of partitioned between-car barriers can have various configurations, shapes, and sizes as needed. Additionally, although the illustrated embodiments have an outer wall with one partition segment and two generally parallel partition segments, other numbers and arrangements of partition segments can be utilized depending on, for example, required dimensions, strength, and flexibility. Certain insubstantial modifications, alterations, and substitutions can be made to the described embodiments without departing from the scope of the invention, as recited in the accompanying claims.

What is claimed:

1. An apparatus for restricting access to a space between adjacent vehicle cars, comprising:
a first deformable barrier member, said first barrier member being secured to a first vehicle car; and
a second deformable barrier member, said second barrier member being secured to a second vehicle car,
at least one of said barrier members being partitioned,
said first and second barrier members extending from respective vehicle cars and cooperating to form a barrier and an open space above said barrier, said barrier restricting access to the space between the first and second vehicle cars.

2. The apparatus of claim 1, said partitioned barrier member defining a plurality of apertures.

3. The apparatus of claim 2, the apertures extending in a vertical direction through said partitioned barrier member.

4. The apparatus of claim 2, the apertures extending in a vertical direction partially through the partitioned barrier member.

5. The apparatus of claim 1, said first and second barrier members cooperating to define a space of about 2″ to about 4″ there between when the first and second vehicle cars are generally aligned.

6. The apparatus of claim 1, said first and second barrier members being in a relaxed state when the first and second vehicle cars are generally aligned.

7. The apparatus of claim 1, said first and second barrier members contacting each other and assuming a deformed state when the first and second vehicle cars traverse a sufficiently sharp curve.

8. The apparatus of claim 7, said first and second barrier members sliding along or abutting each other in the deformed state.

9. The apparatus of claim 7, said first and second barrier members returning from said deformed state to said relaxed state when the first and second vehicle cars pass the sufficiently sharp curve and become generally aligned.

10. The apparatus of claim 1, said first and second barrier members being approximately the same size.

11. The apparatus of claim 1, said first and second barrier members being approximately the same shape.

12. The apparatus of claim 1, said partitioned barrier member having:
a flexible outer wall; and
a first partition segment, said first partition segment being bounded by sections of said outer wall.

13. The apparatus of claim 12, said flexible outer wall comprising a loop.

14. The apparatus of claim 12, said flexible outer wall including a plurality of generally straight sections and an arcuate section adjoining said straight sections.

15. The apparatus of claim 14, said straight sections being generally parallel to each other.

16. The apparatus of claim 14, said partition segment extending between said straight sections.

17. The apparatus of claim 12, said partition segment comprising a stiffening member.

18. The apparatus of claim 12, said partition segment extending for a portion of the height of the outer wall.

19. The apparatus of claim 12, said partition segment extending along the entire height of the outer wall.

20. The apparatus of claim 12, said partitioned barrier including a second partition segment, said first and second partition segments being bounded by sections of said outer wall.

21. The apparatus of claim 20, said first and second partition segments being generally parallel to each other.

22. The apparatus of claim 20, said first and second partition segments being generally orthogonal to said outer wall sections that bound said first and second partition segments.

23. The apparatus of claim 20, said first partition segment being generally orthogonal to a section of said outer wall, and said second partition segment being at an angle relative to said first partition segment.

24. The apparatus of claim 20, said first and second partition segments each extending between sections of said outer wall.

25. The apparatus of claim 20, said first partition segment extending between sections of said outer wall, and said second partition segment extending between said first partition segment and said outer wall.

26. The apparatus of claim 20, said partitioned barrier member including a third partition segment, said first, second and third partition segments being bounded by sections of said outer wall.

27. The apparatus of claim 26, wherein said first partition segment extends between said second and third partition segments.

28. The apparatus of claim 1, said first and second barrier members each being partitioned.

29. The apparatus of claim 1, further comprising first and second mounts, wherein
said first and second mounts are connected to respective first and second vehicle cars, and
said first and second barrier members are secured to respective first and second mounts.

30. The apparatus of claim 29, wherein at least one barrier member is fixed to a mount.

31. The apparatus of claim 29, wherein at least one barrier member is removably secured to a mount.

32. The apparatus of claim 31, wherein said barrier member is slidably secured to said mount.

33. An apparatus for restricting access to a space between adjacent vehicle cars, comprising:
first and second flexible partitioned members; and
first and second mounts, wherein
said first and second mounts are configured to be connected to respective first and second adjacent vehicles, said first and second partitioned members are secured to respective first and second mounts, said first and second partitioned members extend from respective mounts and cooperate to form a barrier and an open space above said barrier, said barrier restricting access to the space between the first and second vehicle cars.

34. The apparatus of claim 33, said first and second partitioned members each defining a plurality of apertures.

35. The apparatus of claim 34, the apertures extending in a vertical direction through respective partitioned barrier members.

36. The apparatus of claim 34, the apertures extending in a vertical direction partially through respective partitioned barrier members.

37. The apparatus of claim 33, said first and second partitioned members cooperating to define a space of about 2″ to about 4″ there between when the first and second vehicle cars are generally aligned.

38. The apparatus of claim 33, said first and second partitioned members being in a relaxed state when the first and second vehicle cars are generally aligned.

39. The apparatus of claim 33, said first and second partitioned members contacting each other and assuming a deformed state when the first and second vehicle cars traverse a sufficiently sharp curve.

40. The apparatus of claim 39, the first and second partitioned members sliding along or abutting each other in the deformed state.

41. The apparatus of claim 39, wherein said first and second partitioned members return from said deformed state to said relaxed state when the first and second vehicle cars pass the sufficiently sharp curve and become generally aligned.

42. The apparatus of claim 33, said first and second partitioned members being approximately the same size.

43. The apparatus of claim 33, said first and second partitioned members being approximately the same shape.

44. The apparatus of claim 33, each partitioned member having:
a flexible outer wall; and
at least one partition segment that is bounded by sections of said outer wall.

45. The apparatus of claim 44, said flexible outer wall comprising a loop.

46. The apparatus of claim 44, said flexible outer wall including a plurality of generally straight sections and an arcuate section adjoining said straight sections.

47. The apparatus of claim 46, said straight sections being generally parallel to each other.

48. The apparatus of claim 46, said at least one partition segment extending between said straight sections.

49. The apparatus of claim 44, said at least one partition segment being a stiffening member.

50. The apparatus of claim 44, said at least one partition segment extending for a portion of the height of the outer wall.

51. The apparatus of claim 44, said at least one partition segment extending for the entire height of the outer wall.

52. The apparatus of claim 44, each partitioned barrier member including a second partition segment, said first and second partition segments being bounded by sections of said outer wall.

53. The apparatus of claim 52, said first and second partition segments being generally parallel to each other.

54. The apparatus of claim 52, said first and second partition segments being generally orthogonal to said outer wall sections that bound said first and second partition segments.

55. The apparatus of claim 52, said first partition segment being generally orthogonal to a section of said outer wall, and said second partition segment being at an angle relative to said first partition segment.

56. The apparatus of claim 53, said first and second partition segments each extending between sections of said outer wall.

57. The apparatus of claim 52, said first partition segment extending between sections of said outer wall, and said second partition segment extending between said first partition segment and a section of said outer wall.

58. The apparatus of claim 52, said partitioned barrier member including a third partition segment, said first, second and third partition segments being bounded by sections of said outer wall.

59. The apparatus of claim 58, wherein said first partition segment extends between said second and third partition segments.

60. The apparatus of claim 33, said first and second barrier members being removably secured to respective mounts.

61. The apparatus of claim 60, said first and second mounting members being slidably secured to respective mounts.

62. A method for restricting access to a space between two adjacent vehicle cars, comprising:
providing first and second flexible partitioned barrier members;
providing first and second mounts;
securing the mounts to respective first and second vehicle cars;
securing the barrier members to respective mounts, wherein the first and second barrier members extend from respective vehicle cars and cooperate to form a barrier and an open space above the barrier, the barrier restricting access to the space between the vehicle cars.

63. The method of claim 62, further comprising deforming the first and second barrier members when the vehicle cars traverse a sufficiently sharp curve.

64. The method of claim 63, further comprising relaxing the first and second barrier members when the first and second vehicle cars pass the curve and become generally aligned.
